(19) United States
(12) Patent Application Publication
(10) Pub. No.: US 2026/0236653 A1
(43) Pub. Date: Aug. 13, 2026

(54) EDGE-WEIGHTED GRAPH NEURAL NETWORKS FOR POST-PLACEMENT INTERCONNECT CAPACITANCE ESTIMATION OF ANALOG CIRCUITS

(71) Applicant: Drexel University, Philadelphia, PA (US)

(72) Inventors: Ioannis Savidis, Wallingford, PA (US); Zhengfeng Wu, Philadelphia, PA (US); Pratik Shrestha, Philadelphia, PA (US)

(73) Assignee: Drexel University, Philadelphia, PA (US)

(21) Appl. No.: 19/300,526

(22) Filed: Aug. 14, 2025

Related U.S. Application Data
(60) Provisional application No. 63/683,104, filed on Aug. 14, 2024.

(51) Int. Cl. G06F 30/33; G06F 30/27

(52) U.S. Cl. CPC G06F 30/33; G06F 30/27

(57) ABSTRACT

The method represents a circuit as a graph where nodes correspond to devices or interconnect segments, and edges represent electrical or physical relationships. Node features may include electrical parameters, geometric attributes, connectivity data, parasitic estimates, and congestion metrics. Spatial relationships between devices or segments are incorporated into the graph using distance-based edge weights, computed using Manhattan, Euclidean, Chebyshev, or other distance metrics, or via learned spatial embeddings. The graph is processed by a graph neural network (GNN) architecture, which may include GraphSAGE, Relational Graph Convolutional Networks (RGCN), Graph Attention Networks (GAT), Spatial Graph Convolutional Networks (SGCN), or other spatially aware GNN models. Node embeddings are updated to capture spatial and topological context, and a prediction module outputs capacitance values for nets or net segments. The framework supports both transistor-level graphs for analog circuits and interconnect-level graphs for digital circuits, enabling accurate capacitance estimation at schematic, post-placement, or post-routing stages.

### BACKGROUND

This disclosure includes 2 subsections grouped under I and II within each section. Each section includes figures, tables, and equations that are preceded by a corresponding section number. For example, the Figures related to Section I all begin with 1.

### I. Background for Edge-Weighted Graph Neural Networks for Post-Placement Interconnect Capacitance Estimation of Analog Circuits

As IC fabrication technology scales, the decrease in the dimensions of the interconnects has resulted in impedances that impact the performance of a circuit. For digital circuits, interconnects account for the majority of signal delay, contributing more delay than the logic gates. The focus of analog IC design has also shifted from device optimization to co-optimization of devices and interconnects. The impact of interconnect capacitance must, therefore, be compensated for during the early design stages of an analog circuit.

Accurate estimates of the interconnect impedance and the resulting impact on circuit performance are challenging at the schematic level due to the lack of physical layout information. For digital circuits, heuristic techniques such as wire load models have been used during logic synthesis to estimate routing length and net impedances, which leverages information from the standard-cell library and the structural features of the design. An objective of analog design at the schematic level is the optimization of the sizes of devices, while wires are often considered ideal without impedance characteristics.

After placement, techniques have been proposed to estimate wire length more accurately. Interconnect impedances are then estimated using the predicted wire length and the characterized process parameters including the per-unit-area capacitance of a given metal layer. Based on the locations of the devices, methods such as half-perimeter wire length (HPWL) and Steiner-tree models provide a more accurate estimate of the interconnect impedance.

Parasitic extraction (PEX) solvers provide accurate modeling and evaluation of interconnect impedances after routing. However, the solvers are computationally expensive, especially for large circuits. Many iterations of modifications to the schematic and layout are required after analyzing post-layout simulation to compensate for the effects of interconnect impedance on the circuit's performance. To reduce design turnaround time, estimating the impedances of the interconnects at early design stages is beneficial, particularly for critical signal nets with large capacitance.

Interconnect capacitance models typically account for the sum of the parallel-plate and fringe capacitance. The capacitance of an interconnect, however, is affected by factors that include the shape of the net, metal overlap area, and distance to the substrate.

An analytical approach to estimate the interconnect capacitance based on geometry and process parameters is proposed n other approaches. The analytical method provides an estimate of the interconnect capacitance of a layout generated without detailed routing to achieve faster turnaround time.

In recent years, machine learning has been embedded into automated IC synthesis flows to predict circuit parameters during early stages of the design process. For digital ICs, machine learning (ML) models are used to estimate wire length and timing.

Linear discriminant analysis (LDA) is used to process features, which are then used by machine learning models to predict wire length based on placement information. XGBoost is applied to predict the interconnect impedance and timing profile of a circuit after placement and clock tree synthesis. In one approach, a spatial graph convolutional network (GCN) is used that includes cell coordinates as features to allow for the post-placement prediction of the interconnect capacitance of a digital circuit. In the analog domain, a random forest model is developed for pre-layout estimation of the interconnect impedance. A star topology is used to model multi-port nets. An ensemble of graph neural network (GNN) models is implemented to estimate the parasitic parameters of both devices and interconnects. However, the models developed are primarily applied at the schematic level, which ignores spatial information provided post-placement. In one approach, text embedding and self-attention are used as additional features to predict distances between placed devices. The pairwise Euclidean distance between devices is set as the prediction target rather than as a feature.

### II. Background for Graph Representation Learning for Parasitic Impedance Prediction of the Interconnect

A significant portion of the run time of modern electronic design automation (EDA) is spent on iterative execution of the design flow to meet the target circuit specifications and timing constraints. Timing verification in the early stage of physical design depends on the accurate estimate of interconnect parasitics. While performing static timing analysis (STA) is possible after standard cells are placed, no interconnect topology is defined until detailed routing. Since routing requires significant computational resources, a predictive tool that provides an accurate estimate of the post routing interconnect parasitics after placement significantly reduces the time to complete the netlist and the parasitic reports.

### SUMMARY OF THE EMBODIMENTS

### I. Summary for Edge-Weighted Graph Neural Networks for Post-Placement Interconnect Capacitance Estimation of Analog Circuits

With technology scaling, interconnect impedance becomes a dominant factor that affects the performance of integrated circuits. Estimating the interconnect impedance of analog circuits at early design stages has been a persistent challenge, primarily due to the lack of detailed layout information. Even with accurate parasitic extraction after routing, many iterations of modifications to the design are required to compensate for the effects of interconnect impedance. To address this challenge, a novel approach is proposed leverages graph neural networks (GNNs) for the estimation of the interconnect capacitance of an analog circuit at both the schematic and postplacement stages of the design flow. A device-level circuit is represented as a heterogeneous graph, where two node types are used, one representing transistors and the other representing nets. The GNN model, specifically, the relational GraphSAGE network, is applied to update the embeddings of net nodes, which are then used to predict the lumped capacitance of a net. To allow the model to learn the spatial relationships between devices after placement, the pairwise Manhattan distances between devices are used as edge weights during the aggregation of node embeddings. A dataset of ten analog circuits is used to evaluate the proposed model. The developed GNN model for post-placement prediction of capacitance that uses pairwise Manhattan distances results in an R 2 score of 0.73 and a mean absolute error of 0.26 fF, outperforming both the schematic-level prediction model and the post-placement prediction model that directly uses device coordinates as features. Results confirm that the proposed model effectively estimates the interconnect capacitance of analog circuits at early design stages while requiring a small dataset for training. In some embodiments, spatial relationships are modeled via distance metrics including Manhattan, Euclidean, Chebyshev, or learned spatial embeddings; and the GNN architecture may be GraphSAGE, RGCN, GAT, GCN, SGCN, or combinations thereof.

In this work, a GNN model is developed to predict interconnect capacitance at both the schematic level and after placement. Specifically, for post-placement prediction of the interconnect capacitance, an edge-weighted GNN is developed that learns from the Manhattan distance between devices.

### II. Summary for Graph Representation Learning for Parasitic Impedance Prediction of the Interconnect

An accurate early estimate of the post routing interconnect parasitics allows for pre-emptive changes to the circuit in earlier phases of the design flow, significantly reducing the design time and effort. In this work, graph-based deep regression models are proposed to predict the post-routing interconnect capacitance of a circuit by using layout information and the post-placement estimates of the interconnect parasitics. The post placement capacitance determined by a commercial physical design tool is used as a baseline for the models, with the mean absolute percentage error (MAPE), the mean absolute error (MAE), and R2 score calculated for comparison. The proposed methodology outperforms the baseline provided by the commercial physical design tools based on results obtained across all trained models, with an average improvement of 23.39% in MAPE, 5.33% in MAE, and 1% in R2 score. The proposed methodology also provides better prediction of the worse case errors as compared to the commercial tool, with the model providing an average improvement of 47.43% in MAPE and 14.31% in MAE for the nets with the largest 1% of errors as determined by the tool.

A novel graph-based regression framework is introduced to predict the post routing interconnect capacitance after the placement of a digital circuit. The framework uses, as input data for the models, the post-placement estimates of the interconnect impedance within a spatial graph representation that includes node features populated from the circuit netlist and the parasitic reports. The contributions of the paper include

A netlist to interconnect graph representation with embedded node feature attributes, and

A graph-based deep neural regression model to predict the total capacitance of each interconnect net of a circuit.

### BRIEF DESCRIPTION OF THE DRAWINGS

FIG. 1.1 shows a block-level representation depicting the developed ML flow that predicts the interconnect capacitance. The architecture of the GNN model is also shown.

FIG. 1.1.1 shows Table 1.1.

FIG. 1.2a and 1.2b show characterization of the predicted and actual capacitance of circuit nets on a normalized scale for the FIG. 1.2a) schematic level model and FIG. 1.2b) post-placement level model.

FIG. 1.2.1 shows Equations 1.1-1.6.

FIG. 1.3 shows the ranking of the importance of the four transistor features and the net feature for the prediction of the interconnect capacitance.

FIG. 2.1a-2.1c show an analysis of the (FIG. 2.1a) post placement and post routing interconnect capacitance, (FIG. 2.1b) post placement interconnect capacitance histogram (log scaled), and (FIG. 2.1c) post routing interconnect capacitance histogram (log scaled).

FIG. 2.1.1 shows Table 2.1.

FIG. 2.1.2 shows Table 2.2.

FIG. 2.1.3 shows Table 2.31.

FIG. 2.1.4 shows Table 2.4.

FIG. 2.1.5 shows Table 2.5.

FIG. 2.2a-2.2d show post placement and post routing interconnect capacitance distributed by post placement capacitance ranges of (FIG. 2.2a) 0 to 0.1 fF, (FIG. 2.2b) 0.1 to 1 fF, (FIG. 2.2c) 1 to 10 fF, and (FIG. 2.2d) 10 fF and above.

FIG. 2.2.1 shows Equations 2.1 to 2.7.

FIG. 2.3 shows the dataset generation and deep learning framework for post placement to post routing interconnect parasitic impedance prediction.

FIG. 2.4a and 2.4b show geometrical representation of the (FIG. 2.4a) routing estimated based on the post placement SPEF file and (FIG. 2.4b) interconnect spatial graph based on the estimated routing.

FIG. 2.5 shows a graph regression network architecture.

### DETAILED DESCRIPTION OF THE EMBODIMENTS

### I. Description for Edge-Weighted Graph Neural Networks for Post-Placement Interconnect Capacitance Estimation of Analog Circuits

### Methodology and Problem Formulation

More recently, GNNs have become popular for modeling integrated circuits where the circuits are represented as graphs. The topological graph structure is leveraged as an additional feature for learning. The feature embeddings of a graph node are updated by aggregating with the feature embeddings of neighboring nodes to account for graph structure of a given node. In this work, a device-level circuit is represented as a heterogeneous graph with two node types, one representing transistors and the other nets. For schematic-level prediction, three edge types are defined that indicate the three possible connections between a net and a terminal (drain, gate, and source) of a transistor.

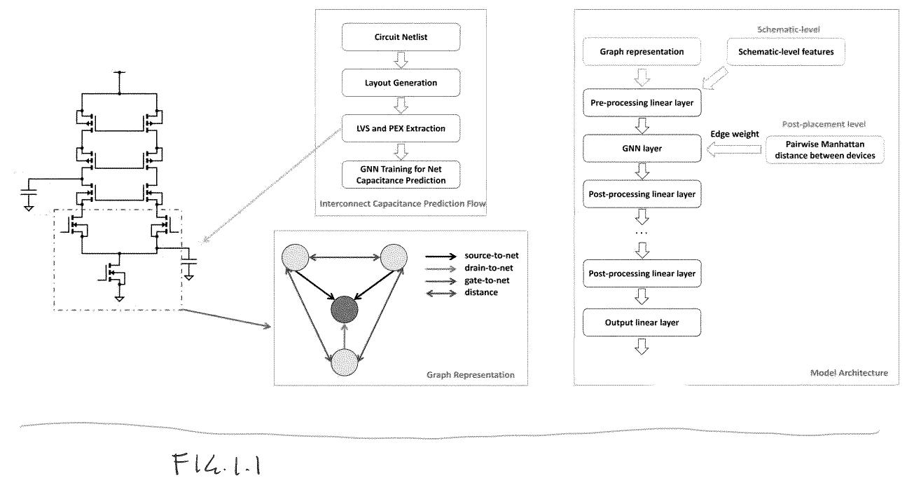

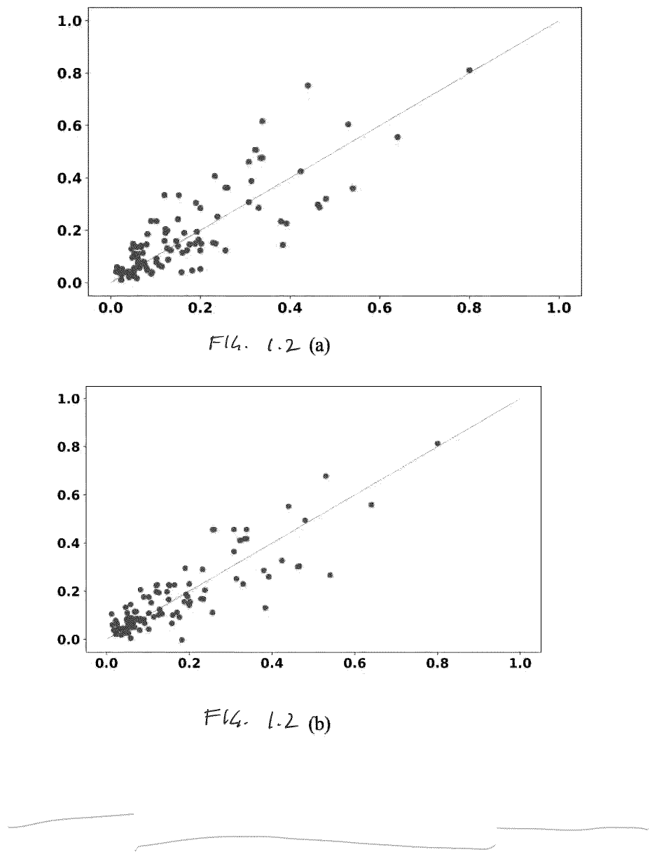

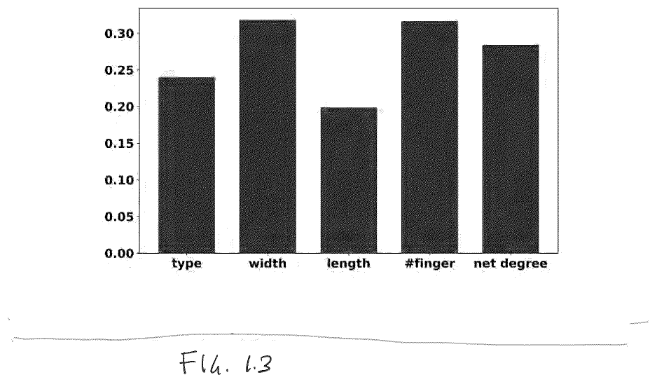

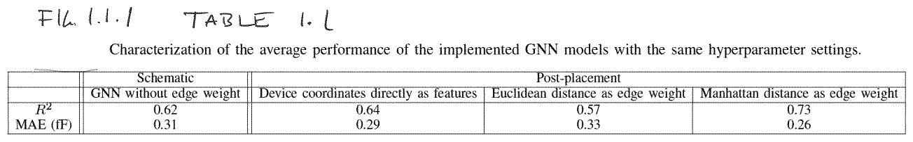

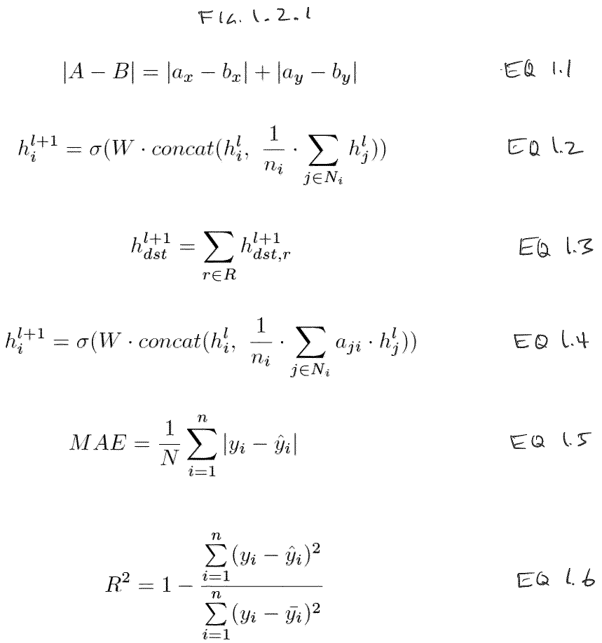

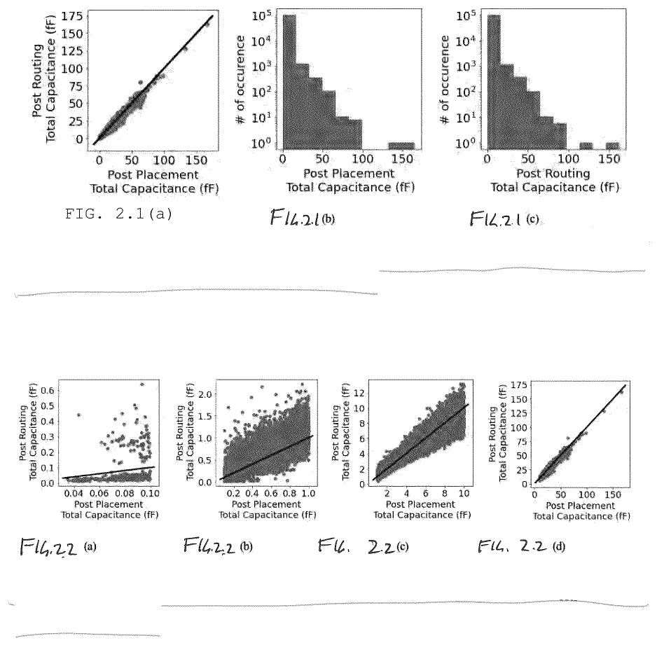

For post-placement estimation of the parasitic impedance, the geometry of the interconnects is still not available. However, the locational coordinates of the placed devices provide additional information beyond schematic-level features. Efectively leveraging placement information as graph features for learning improves model performance. However, directly including the absolute coordinates of devices as node features does not result in optimal learning by the neural network. For example, the same layout shifted to different locations or with different placement configurations results in unique coordinates that confuse the models and increase prediction error. In this work, an additional distance edge type is defined, where an edge is added between every pair of transistors that share a common net. The pairwise Manhattan distance between transistors, calculated from the coordinates of the midpoint of the devices, is used as an edge weight expressed in Equation 1.1 (FIG. 1.2.1), where ai and bi represent coordinates of transistor a and transistor b at the ith dimension. Alternative distance metrics (Manhattan, Euclidean, Chebyshev, learned embeddings) may be used alone or in combination as edge weights; absolute or relative coordinates may be used as features in some embodiments.

As a result, transistors that are placed further apart are associated with a larger edge weight. For a two-pin net that connects two transistors, the Manhattan distance between the transistors provides an estimate of the routing length, which is also correlated to the capacitance of the interconnect. For multi-pin nets that connect more than two devices, the routing is more complex. However, the model automatically learns to predict the interconnect capacitance based on the final embeddings of a net node, which encode information on the embeddings of transistors incident on the net.

The transistor nodes are described by a categorical feature indicating the transistor type (N-type or P-type) and numerical features that include the width, length, and number of fingers. At the schematic level, net nodes do not include any processdependent features. Instead, the degree of a node, which indicates the number of transistor nodes connected to a net, is used as an augmented feature.

The GNN layer used in this system combines the principles of a GraphSAGE network and a relational graph convolutional network (RGCN). With GraphSAGE, the embedding of a node is updated by concatenating with the mean of the embeddings of neighboring nodes, expressed in Equation 1.2. FIG. 1.2.1, where o is the nonlinear activation function, W is the weight matrix, Ni is the set of neighboring nodes of node i, and ni is the size of Ni. In other embodiments, the GNN may be implemented using GCN, GAT, RGCN, GraphSAGE, or hybrids thereof; the number of aggregation layers and fully connected layers may vary.

The GraphSAGE operation is executed to update node embeddings independently for each incident edge type. The final embedding of a destination (dst) node is the sum of the embeddings of all edge types, as given by Equation 1.3 (FIG. 1.2.1), where R is the set of all defined edge types.

After placement of an analog circuit, while using the additional distance edge type, the pairwise device distances are used as edge weights in the GraphSAGE layer to update the embeddings of transistor nodes, as given by Equation 1.4 (FIG. 1.2.1), where where aji is the edge weight (pairwise distance) between transistor j and transistor i.

The updated embeddings of net nodes from the GNN layers are then passed through post-processing linear layers, which generate predictions for the lumped capacitance of each net node. With the developed GNN model, the problem of estimating interconnect impedance is, therefore, transformed into a node-level prediction task, where the labels of net nodes are set as the prediction labels.

The mean absolute error (MAE) and R2 score are used as metrics to evaluate the performance of the prediction models, and are defined as, respectively, in Equations 1.5 and 1.6 (FIG. 1.2.1), where where y denotes the actual values, y\hat{ } the predicted values, and y the mean of the actual values.

### Characterization of the ML Impedance Models

The dataset used to characterize the developed models includes 10 analog circuits with a total of 161 transistors and 121 nets implemented in a 65 nm technology. The circuits include amplifiers, filters, buffers, and oscillators. The layout of the 10 circuits is generated with MAGICAL from sized schematic level netlists. After ensuring that the circuit passes a layout-versus-schematic (LVS) check, parasitic extraction is performed on the layout with Calibre xRC. The lumped total capacitance to ground is extracted for each net of each circuit. For scenario 1 (schematic-level prediction), the graphs and features are constructed based solely on information from the SPICE netlist. For scenario 2 (post-placement prediction), the device coordinates are parsed from DSPF files and used. Edges are added between connected devices and labeled with weights representing the pairwise Manhattan distance, which uses the positional encoding of device nodes.

Heterogeneous graphs that represent the circuit topological structures are generated based on the SPICE netlist. Graph nodes that represent the supply and ground nets are removed as the primary objective of the model is to predict the capacitance of signal nets. Cross-validation is used to characterize the model, where one circuit is used for testing and the remaining nine circuits are used for training in each executed iteration. The performance of the model is characterized and analyzed at both the schematic level and post-placement to predict the interconnect capacitance.

Three post-placement prediction models are implemented and compared. For the first model, device coordinates are used directly as features of transistor nodes.

Euclidean distance is used in the second model as an edge weight, while Manhattan distance is used in the third model as an edge weight. After hyperparameter tuning, the GNN model includes one pre-processing layer, one GNN layer, and six postprocessing linear layers. The pre-processing linear layer maps the different input feature dimensions of the transistor nodes and net nodes to the same dimension. The hidden dimension of the GNN layer is 16, while the hidden dimension of each linear layer is 12. A block-level representation of the flow used to estimate the interconnect capacitance and the model architecture is shown in FIG. 1.1. The average performance from executing the models five times for each of the four application scenarios with the same hyperparameter settings is listed in Table 1.I (FIG. 1.1.1).

### Analysis of Results

As compared to the GNN model without edge weights used for schematic-level prediction, the edge-weighted GNN model that uses the pairwise Manhattan distance between devices for post-placement prediction of the interconnect capacitance results in an improvement of 17.7% in R2 score and a decrease in MAE of 16.12%, as indicated by the results listed in Table 1.I. The predicted and actual capacitance for each scenario is shown in FIG. 1.2a and 1.2b. The results indicate that the postplacement prediction more closely matches the actual extracted capacitance, particularly for nets with small capacitance. The results confirm that the inclusion of the device placement information in the GNN model provides improved prediction performance.

Among the three models implemented for post-placement estimation of the interconnect capacitance, the edge-weighted GNN model results in the highest R2 score of 0.73. As indicated by the results listed in Table 1.I, the model that uses device coordinates directly as features of transistor nodes only results in a marginal improvement of 3% in R2 over the schematic-level model. The results suggest that the edge weights are important for capturing the spatial relationships between devices, which are critical for accurate prediction of the interconnect capacitance. In addition, using pairwise Euclidean distance instead of Manhattan distance between transistors results in worse performance than even the schematic-level model. The primary cause for loss in prediction accuracy is that the most common interconnect routes are better represented by Manhattan distances rather than the diagonal routes Euclidean distance represents.

Stacking k GNN layers results in the aggregation of node embeddings from a k-hop neighborhood of a given node. Hyperparameter tuning, however, suggests that using two or three GNN layers yields worse performance than using a single GNN layer. Unlike graph-level tasks such as performance modeling of the entire circuit, 1-hop aggregation is sufficient for inductive generalization, including for the estimation of the interconnect capacitance. 1-hop aggregation is sufficient as interconnect capacitance (excluding coupling) is only affected by the devices directly connected to the net. An analysis of the importance ranking of all the features used with the edge-weighted model for the prediction of interconnect capacitance is performed with GNNExplainer, with results as shown in FIG. 1.3. A higher score indicates a feature with greater importance for the prediction. The bar plot indicates that the width and the number of fingers of a transistor are the most important features for the prediction of interconnect capacitance. The degree of a net, used as an augmented feature of net nodes, also impacts the performance of the model.

For non-graph-based approaches, a dataset of interconnect capacitances is constructed by extracting the parasitic impedance of each net of a circuit as a standalone data point. For digital circuits, individual timing paths are extracted for training. The primary advantage of using GNNs is that the local graph of a net is automatically extracted and considered during learning. Inductive GNN models including GraphSAGE learn effectively from local graphs without requiring the entire circuit graph.

The dataset used in this work is smaller than the commercial datasets used in previous approaches, where 452K nets and 725K nets are included, respectively. The large proprietary datasets are only available to IP owners, making such datasets inaccessible to many researchers and practitioners. In contrast, the GNN model in this work is trained with a dataset containing nine circuits. Therefore, the proposed technique is more dataefficient and provides utility to estimate the capacitance of an interconnect with limited data availability.

Note that the lumped capacitance model of interconnects is only valid for operating frequencies of up to a few gigahertz. To model circuits that operate at higher frequencies, the prediction of a distributed interconnect model or the prediction of the S-parameters of the interconnects is more suitable.

### Conclusions

In this work, GNNs are developed for the estimation of interconnect capacitance at both the schematic level and after placement. The pairwise Manhattan distances of devices are used as edge weights for GNN aggregation when using the model for the post-placement prediction of the net capacitances. Results indicate that the edge-weighted post-placement model outperforms both the schematic-level model and the post-placement model that directly uses device coordinates as node features, providing an R2 score of 0.73. The developed model provides utility in estimating the capacitance of signal nets, specifically to identify nets with large capacitance early in the design flow, which effectively reduces the design turnaround time.

### II. Description for Graph Representation Learning for Parasitic Impedance Prediction of the Interconnect Graph Representation Learning

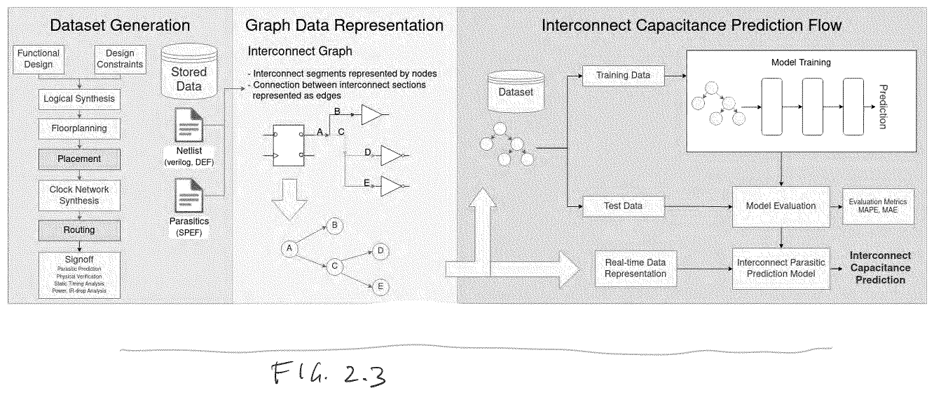

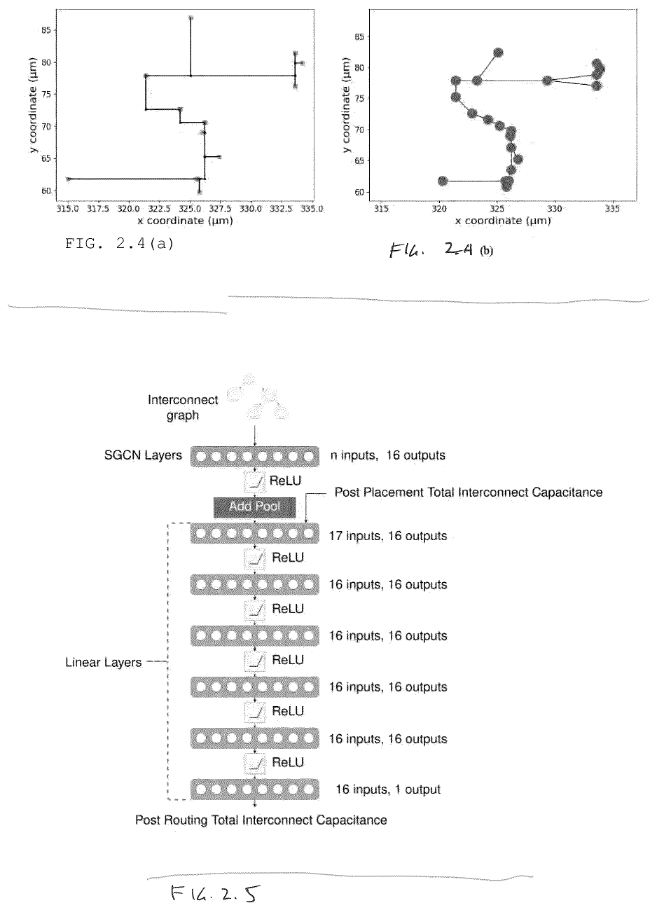

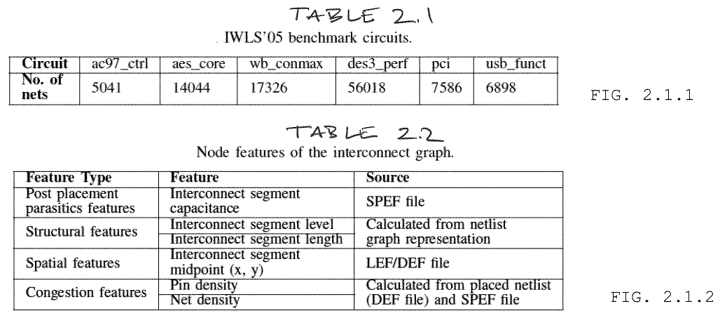

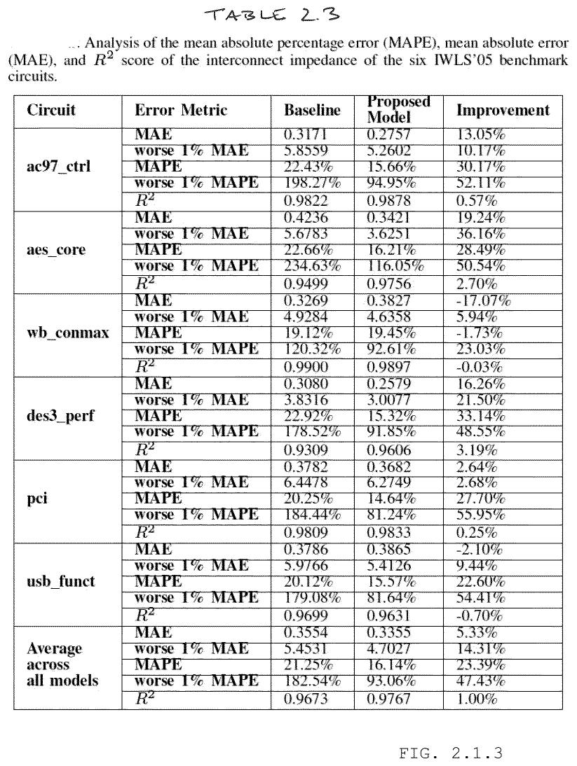

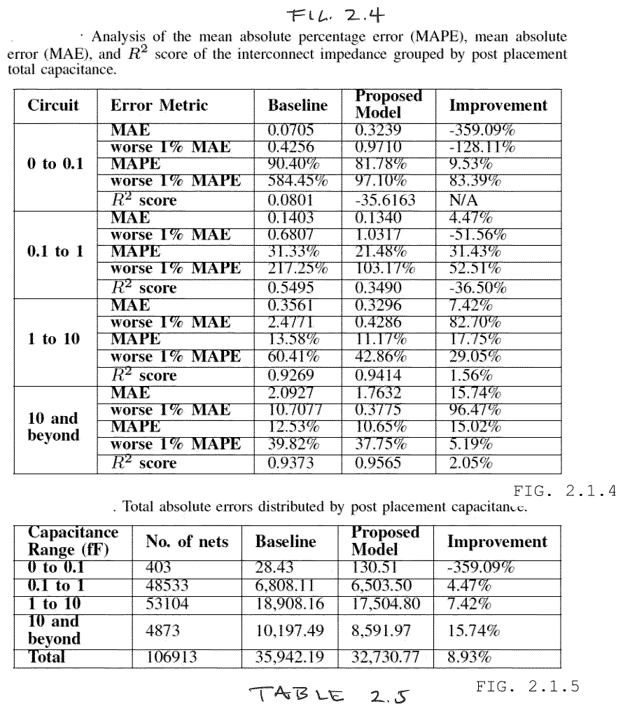

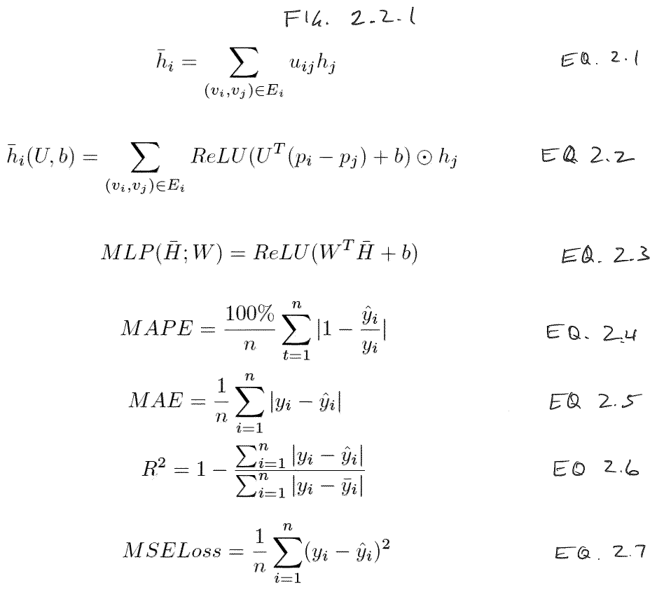

In this work, spatial graph convolution layers (SGCN) are used to model interconnect capacitance from a distributed interconnect graph. SGCN extends a normal GCN to leverage node positions within the convolution function and uses spatial features to learn from graphs that have an inherent spatial arrangement. Given a directed graph G=(V, E), where v∈V is a node of the graph and e∈E is an edge of the graph, a graph convolution layer is defined by an aggregation function and multi-layer perceptron. The aggregation function is defined in Equation 2.1 (FIG. 2.1.1), where Ei is the set of edges connecting node vi to all neighboring nodes represented by a set Vj such that node vj∈Vj, hi denotes node features applied as input to a convolutional layer, and uij is a trainable weight for aggregation of node vi with respect to features of node vj. The representation of (1) in matrix form is given by H⁻=UHT, where H denotes the matrix of node features such that H⁻=[h⁻1, . . . , h⁻n], and U denotes a trainable weight matrix. SGCN extends the aggregation function as given by Equation 2.2 (FIG. 2.1.1), where pn is the matrix representation of the coordinate location of node vn, ReLU is a rectified linear activation function, and ⊙ represents element-wise multiplication. The extended aggregation function is used by the multi-layer perceptron layer as given by Equation 2.3 (FIG. 2.1.1), where W and b are the trainable weight matrix and bias vector, respectively. In further embodiments, spatial awareness is realized via GAT, GIN, GraphSAGE, or other spatially aware GNNs; spatial inputs may include coordinates, edge weights from distance metrics, or learned positional encodings.

### Dataset and Baseline Analysis

In this system and method, six IWLS'05 sequential benchmark circuits, which are listed in Table 2.I (FIG. 2.1.1), are used to build a dataset of layouts. The dataset is generated on a 65 nm technology node. The initial benchmark circuit is synthesized into a technology-specific gate-level netlist using Synopsys Design Compiler and the gate-level netlist is placed and routed into a final layout using Synopsys IC Compiler. Interconnect parasitics are also extracted from Synopsys IC Compiler as Standard Parasitic Exchange Format (SPEF) files, with data from the files used to develop model features as listed in Table 2.2 (FIG. 2.1.2). The circuits are synthesized to provide an operating frequency of 1 GHz, a circuit aspect ratio of 0.5, and an area utilization of 70%.

Given the initial (placement) and final (routing) stages of the IC physical design flow, the total capacitance of the initial stage provided by the design tool is considered as the baseline prediction for the parasitic profile of the final stage. Scatter plots of the post placement and post routing interconnect capacitance of the entire dataset are shown in FIG. 2.1a. The metrics evaluating the error, specifically the MAPE, MAE, and R2 score, are selected as a baseline and are calculated as, respectively, in Equations 2.4-6 (FIG. 2.1.1), where n is the total number of nets in the overall dataset, y is the interconnect capacitance post routing, y\hat{ }is the estimated interconnect capacitance post placement, and y is the average interconnect capacitance post routing. The baseline errors for each of the circuits are listed in Table 2.3 (FIG. 2.1.3). There is a significant error between the capacitance provided from the two different design stages, especially when considering the maximum average errors and average percentage errors in certain critical interconnect.

Histograms of both the post placement and post routing interconnect capacitance are shown in FIG. 2.1 b and 2.1 c, respectively. A significantly left-skewed logarithmic distribution of the interconnect capacitance is observed. Upon grouping the net capacitances from all circuits into the ranges of 0 to 0.1 fF, 0.1 to 1 fF, 1 to 10 fF, and 10 fF and above, the larger interconnects, although resulting in lower proportional error, are observed to contribute more to the total error of the model. Scatter plots of the post placement and post routing interconnect capacitance grouped by total net capacitance are provided in FIG. 2.2a-2.2d. The mean and max absolute and percentage errors by benchmark circuit and by total interconnect capacitance are listed in Tables 2.3 and 2.4 (FIG. 2.1.3 and 2.1.4), respectively.

### Graph-Based Parasitic Prediction

To predict the total capacitance of an interconnect, the routed nets from the physical implementation of the circuit (DEF file) are mapped into directed graphs and are populated with node features extracted from both the netlist and reports on the parasitic impedance.

### A. Graph Structure and Feature Engineering

The overall execution of the framework and training process is shown in FIG. 2.3. The SPEF file generated post placement provides an estimated parasitic impedance of each interconnect of the circuit. As shown in FIG. 2.4a, an estimated routing based on the placed circuit is used to calculate the distributed parasitic impedance of each net. The physical characteristics of the circuit, described in the Verilog, DEF, and SPEF files, are parsed and represented as an interconnect graph G=(V, E), where node v∈ V represents estimated interconnect segments and edge e∈ E represents a connection between two or more interconnect segments. A spatial graph is depicted in FIG. 2.4b that is based on the estimated post placement interconnect shown in FIG. 2.4a. The interconnect graphs represent primary inputs to the model.

Each node of an interconnect graph is populated with a carefully selected feature set, which is listed in Table 2.2. Parasitic features are net capacitance values extracted from the SPEF files generated by IC Compiler. Both the total parasitic impedance of each net and the distributed parasitic impedance of each net segment are extracted from the SPEF file. Interconnect graphs are traversed to compute structural features, whereas spatial features are calculated as the midpoint of the estimated location of the interconnect segments provided in the SPEF file. The interconnect segments of the SPEF file are also used to calculate the congestion features of each node of the interconnect graph. The circuit layout is partitioned into a grid of cells each with dimension of 10×10 μm2 and the pin and node density is calculated for each cell of the grid. The mean and sum of all the cells through which the interconnect passes are considered as the congestion feature of the graph node representing the given interconnect segment.

### B. Model Architecture and Training

After completing feature extraction and graph representation of the circuit, a regression model is developed to predict the interconnect parasitics. The regression model, as shown in FIG. 2.5, is a deep neural network includes an SGCN layer connected to six linear layers of size 16. Each hidden layer uses a rectified linear unit (ReLU) as an activation function. A gradient clipping for weights greater than 1 is applied after each activation to avoid exploding gradients. The primary objective function is to minimize the mean squared error (MSE) loss between the actual post routing interconnect capacitance y and the predicted estimate of the post routing interconnect capacitance y\hat{ }. The MSE loss is given by Equation 2.7 shown in FIG. 2.2.1, where n is the total number of nets in the dataset.

### Results

In this section, an analysis of the results produced by the parasitic prediction framework described in Section IV is provided. The dataset from the six circuits listed in Table 2.I is distributed for six instances of the proposed neural regression model, where for each model, one of each circuit is considered as a test set, and the remaining five circuits are considered as the training set. The models are trained with a stochastic gradient descent (SGD) optimizer and divided into batches of 1024 interconnect graphs for a single iteration of training and validation. An initial learning rate of 0.01 is applied that decays at a rate of 95% every 10 training steps. Early stopping is adopted such that the training process is terminated when there is no improvement in the training loss for 10 epochs, which prevents the model from overfitting by learning the statistical noise in the training dataset. The framework is implemented in Python 3 using the PyTorch-geometric deep learning library, and the training is performed on a system with 96 GB memory, twenty-four 4 GHZ CPU cores, and an NVIDIA Geforce GTX 1080 graphics card.

The trained regression models are validated against the test datasets. The R2 score, total MAPE, total MAE, and MAPE and MAE of the top 1% worse case errors are calculated for comparison of the models, with the results as listed in Table 2.3. Results obtained across the six models indicate that the proposed methodology outperforms the baseline errors produced by the commercial tool with an average improvement of 23.39% in the MAPE score and 5.33% in the MAE score. The improvement is even greater when considering worse case predictions, with the proposed methodology providing an average gain of 47.43% in MAPE and 14.31% in MAE over the baseline for the top 1% of nets with the largest error estimate. In addition, although there are model scenarios where the commercial tool outperforms the proposed models when considering the full dataset, specifically for wb conmax and pci, the proposed architecture consistently outperforms the baseline across all circuit models for the 1% of nets with the greatest error estimates. Both the baseline and the proposed model provide R 2 scores greater than 0.95 for all training scenarios. However, the proposed model outperforms the baseline by a small margin, with an average improvement of 1%.

As shown in FIG. 2.1b and FIG. 2.1c, the distribution of the interconnect capacitance is heavily left-skewed, indicating that there are a greater number of interconnects with small capacitance as compared to interconnects with large capacitance. However, larger capacitive loads are generally more critical from the perspective of a designer. The dataset is, therefore, sub-divided by the post placement capacitance, where ranges of 0 to 0.1 fF, 0.1 to 1 fF, 1 to 10 fF, and 10 fF and above are considered. The R2 score, total MAPE, total MAE, and MAPE and MAE of the top 1% of nets with the greatest errors are calculated for each range of capacitance as listed in Table 2.4 (FIG. 2.1.4). The proposed SGCN model predictions, when compared to the baseline predictions, result in greater absolute errors (total MAE and worse 1% of nets MAE) for smaller capacitances, which improves with increasing capacitance. The R2 score also indicates that the model performs better for larger capacitances. The R score for both the baseline and the proposed model is low for interconnects with smaller capacitance but improves with increasing capacitance. A negative R2 score of −35.61 for the capacitance range of 0 to 0.1 fF indicates that the proposed model underperforms even as compared to the mean of the expected capacitances. In contrast, the improvements in the proportional errors (total MAPE and worse 1% of nets MAPE) are greater for smaller capacitances when using the SGCN models over the baseline tool, but deteriorate as the capacitance increases. However, the SGCN model outperforms the baseline across all capacitance ranges in MAPE and worse 1% of nets MAPE. Considering the total absolute error across the capacitance ranges listed in Table 2.5 (FIG. 2.1.5), although the proposed model performs 359.09% worse than the baseline for the smallest capacitance range of 0 to 0.1 fF, the prediction error only accounts for 3.17% of the total error of the dataset. The proposed model performs 15.74% better for the largest capacitance range (10 fF and beyond), which contributes 49.99% of the total error of the dataset.

### Conclusions

In this system and method, a deep spatial graph regression model is proposed to predict the post routing interconnect parasitic impedance after completing placement. Interconnect graph representations of six post placement IWLS'05 benchmark circuits are generated. A commercial physical design tool is used to generate the datasets, and an analysis is performed to obtain a baseline error across the circuits. When validating the six trained models, each with data from one of the benchmark circuits as the test set and the rest as the training set, an average improvement of 23.39% in MAPE, 5.33% in MAE, and 1% in R2 score is observed when predicting the postrouting interconnect parasitics after completing placement. When considering the worse 1% of predicted impedance errors, an average improvement of 47.43% in MAPE and 14.31% in MAE is observed as compared to the baseline. The proposed machine learning methodology largely reduces errors and outperforms the baseline provided by the commercial. The improvement is even more significant for interconnects with large errors in predicted impedance.

While the invention has been described with reference to the embodiments above, a person of ordinary skill in the art would understand that various changes or modifications may be made thereto without departing from the scope of the claims.

We claim:

1. A method for estimating interconnect capacitance in an analog circuit after placement, comprising:
generating a heterogeneous graph representing a device-level circuit, including transistor nodes and net nodes;
defining edge weights as Manhattan distances between pairs of transistors sharing a common net;
applying a relational GraphSAGE network to update embeddings of net nodes based on the edge-weighted graph; and
predicting lumped capacitance values for the net nodes using the updated embeddings;
wherein the edge weight is computed using a distance metric selected from Manhattan, Euclidean, Chebyshev, or a learned spatial embedding; and wherein the graph neural network comprises or is selected from GraphSAGE, RGCN, GAT, GCN, SGCN, or combinations thereof.

2. The method of claim 1, wherein each transistor node includes features selected from transistor type, width, length, and number of fingers.

3. The method of claim 1, wherein the net nodes are described using augmented features including net degree.

4. The method of claim 1, wherein the edge weights represent pairwise Manhattan distances computed from the center coordinates of transistors.

5. The method of claim 1, wherein post-processing layers following the GNN generate capacitance predictions using six linear layers, wherein the post-processing module comprises one or more fully connected layers of configurable size.

6. The method of claim 1, wherein the prediction model achieves an R2 score of at least 0.73 and a mean absolute error of less than 0.3 fF.

7. The method of claim 1, wherein the model uses a single GraphSAGE layer followed by linear layers with hidden dimensions of 12, wherein a single aggregation layer or multiple aggregation layers may be used, followed by one or more fully connected layers of configurable dimension.

8. The method of claim 1, wherein device coordinates are parsed from DSPF files and parasitic data is extracted from Calibre xRC.

9. The method of claim 1, wherein nets representing supply and ground are excluded from prediction.

10. The method of claim 1, further comprising ranking feature importance using GNNExplainer to identify most impactful transistor or net features.

11. A method for predicting post-routing interconnect capacitance of a circuit using graph representation learning, comprising:
generating a spatial interconnect graph from circuit layout and parasitic reports;
embedding each node in the graph with features derived from netlist, SPEF, and DEF files;
applying a spatial graph convolutional network (SGCN) to update node embeddings based on spatial structure; and
predicting total interconnect capacitance for each net using the updated node embeddings;
wherein the graph neural network is configured to incorporate spatial information using any of GCN, GAT, GraphSAGE, SGCN, GIN, or hybrids thereof.

12. The method of claim 11, wherein node features include parasitic capacitance, spatial coordinates, congestion features, and segment connectivity.

13. The method of claim 11, wherein the model architecture comprises one SGCN layer followed by six fully connected layers of size 16, wherein the model comprises one or more graph layers followed by one or more fully connected layers, each of configurable size.

14. The method of claim 11, wherein the framework uses stochastic gradient descent with learning rate decay and early stopping.

15. The method of claim 11, wherein the interconnect graphs are constructed by segmenting routed nets based on post-placement DEF files, wherein the segmentation granularity is configurable and may represent physical segments, logical segments, or hybrid partitions.

16. The method of claim 11, wherein congestion features are computed by dividing the layout into 10×10 μm2 cells and averaging density metrics., wherein spatial regions used for congestion features are of configurable size.

17. The method of claim 11, wherein the model is trained and validated using six IWLS'05 benchmark circuits on a rotating test set basis.

18. The method of claim 11, wherein prediction performance is evaluated using mean absolute error, mean absolute percentage error, and R2 score.

19. The method of claim 11, wherein the method further comprises partitioning the dataset by net capacitance range and applying separate trained models to different ranges.

20. A method for predicting interconnect capacitance in an integrated circuit, comprising: constructing a graph representation of the circuit from design data; associating nodes of the graph with electrical, physical, and topological features; applying a graph neural network configured to incorporate spatial information into node embeddings; and generating a predicted capacitance value for at least one net based on the node embeddings.
